(19) United States
(12) Patent Application Publication
(10) Pub. No.: US 2025/0219734 A1
(43) Pub. Date: Jul. 3, 2025

(54) INTERRUPTION SYSTEM CONFIGURED TO CONTROL THE TRANSMISSION OF AN OPTICAL SIGNAL

(71) Applicants: L'AIR LIQUIDE SOCIETE ANONYME POUR L'ETUDE ET L'EXPLOITATION DES PROCEDES GEORGE CLAUDE, Paris (FR); ÉCOLE NATIONALE D'INGÉNIEURS DE BREST (ENIB), Plouzane (FR)

(72) Inventors: Arnaud GARDELEIN, Sassenage (FR); Maeva FRANCO, Sassenage (FR); Ammar SHARAIHA, BREST CEDEX 3 (FR); Pascal MOREL, BREST CEDEX 3 (FR)

(73) Assignees: L'AIR LIQUIDE SOCIETE ANONYME POUR L'ETUDE ET L'EXPLOITATION DES PROCEDES GEORGE CLAUDE, Paris (FR); ÉCOLE NATIONALE D'INGÉNIEURS DE BREST (ENIB), Plouzane (FR)

(21) Appl. No.: 18/844,051

(22) PCT Filed: Mar. 7, 2023
(86) PCT No.: PCT/EP2023/055675

§ 371 Date: Sep. 5, 2024

(30) Foreign Application Priority Data
Mar. 11, 2022 (FR) FR2202160

(51) Int. Cl. H04B 10/291; H04B 10/25; H04B 10/64

(52) U.S. Cl. CPC H04B 10/2914; H04B 10/2589; H04B 10/64

(57) ABSTRACT

Interruption system 10 configured to control transmission of an optical signal, the system comprising a solid state optical amplifier (AMP, AMP1, AMP2) configured to receive:
an input optical signal (SOE, SOE1, SOE2), and
a control signal (SC, SC1, SC2) configured to control the semiconductor optical amplifier (AMP, AMP1, AMP2),
   characterised in that the interruption system further comprises a cooling device (12, 12-1, 12-2) configured to cool the semiconductor optical amplifier (AMP, AMP1, AMP2) to a temperature greater than or equal to 10 K, preferably greater than or equal to 40 K, and to cool the optical modulator to a temperature less than or equal to 90 K, preferably less than or equal to 80 K.

### SCOPE OF THE INVENTION

The invention relates to an interruption system configured to control the transmission of an input optical signal.

### STATE OF THE ART

It is known to use different systems to interrupt the transmission of an input signal.

EP 2 242 191 A2 describes a relay apparatus, a signal processing apparatus and an optical transmission system applied to a passive optical network. U.S. Pat. No. 10,097,281 B1 describes an optoelectronic data link system involving cryogenic cooling. US 2014/139909 A1 describes an optical amplification device.

The micro electromechanical system (MEMs), the thermo-optical system, the electro-optical system and the acousto-optical system are useful systems for transmitting relatively long data packets. However, these systems have the disadvantage, due to their intrinsic limitations, of having a relatively low switching speed between a transmission state and a transmission stop state. These interruption systems are therefore not suitable for an input signal comprising relatively short data packets.

In the context of an opto-electronic amplifier, such as a solid-state optical amplifier, the interruption is controlled by a control signal. When the power of the control signal is too low, the amplifier is no longer powered and is no longer able to receive the input signal. When the power of the control signal is sufficient to power the semiconductor optical amplifier, the latter receives the input signal and is able to amplify it.

There are all-optical systems for interrupting the transmission of the input signal. For all-optical interruption systems, a control signal is formed by an optical signal. The control optical signal is a light pump signal which is used to power the semiconductor optical amplifier and control the on or off state of the amplifier according to the power of the pump light signal.

The use of optical control signal makes it possible to switch between a state allowing the transmission and a state interrupting the transmission of the input signal to the semiconductor optical amplifier for a very short time, compared to the length of the input signal data packets. These interruption systems are therefore adapted to an input signal comprising relatively short and/or relatively long data packets.

However, at room temperature, the use of an all-optical interruption system, such as a semi-conductor optical amplifier, is almost impossible, due to the power of the control signal that would be required by the semiconductor optical amplifier.

There is therefore a need to be able to control the transmission of an input optical signal adapted to the length of the data packets, more particularly to relatively short data packets, while requiring a low power for the control signal.

The aim of the invention is to provide a system to meet these needs.

### BRIEF DESCRIPTION OF THE INVENTION

To this end, the present invention relates to an interruption system configured to control the transmission of an optical signal, the system comprising a semiconductor optical amplifier (AMP, AMP1, AMP2) configured to receive:
an input optical signal (SOE, SOE1, SOE2), and
a control signal (SC, SC1, SC2) configured to control the semiconductor optical amplifier (AMP, AMP1, AMP2),
   characterised in that the interruption system further comprises a cooling device (12, 12-1, 12-2) configured to cool the semiconductor optical amplifier (AMP, AMP1, AMP2) to a temperature greater than or equal to 10 K, preferably greater than or equal to 40 K, and to cool the optical modulator to a temperature less than or equal to 90 K, preferably less than or equal to 80 K.

Advantageously, cooling the optical amplifier to a cryogenic temperature allows switching between transmission and stopping transmission of the input optical signal to the semi-conductor optical amplifier without requiring significant power from the control signal. At such a temperature, the semi-conductor optical amplifier does not need to be electrically powered. Since the switching energy is low, the latter can be transmitted by a control signal, for example in the form of an optical signal.

Advantageously, the fact that the interruption system according to the invention is subjected to a temperature greater than or equal to 10 K, preferably greater than or equal to 40 K and less than or equal to 90 K, preferably less than or equal to 80 K allows the semiconductor optical amplifier to have an extinction rate greater than 30 dB. The extinction rate of the same amplifier at room temperature is of the order of 20 dB.

The extinction rate corresponds to the variation in power, in dB, between the power of the optical signal at the output of the semiconductor optical amplifier in the on state and the power of the optical signal at the output of the amplifier in the off state. The on state occurs when the control signal provides sufficient energy to the semiconductor optical amplifier to power it. Conversely, the off state occurs when the control signal does not provide enough energy to power the semiconductor optical amplifier. It should be noted that in the blocked state the power is non-zero due to the existence of noise.

Advantageously, the interruption system may also comprise one or more of the following features, considered individually or in any technically possible combination:
the control signal is an electrical signal; and/or
the control signal is an optical signal; and/or
the semiconductor optical amplifier is a bi-directional component configured to receive the input optical signal and the control optical signal in opposite directions; and/or
the cooling device is direct; and/or
the cooling device is indirect; and/or
the cooling device is active; and/or
the cooling device is passive; and/or
the cooling device comprises a temperature regulator, the temperature regulator being configured to maintain the semiconductor optical amplifier at a target temperature with a margin less than or equal to +500 mK, preferably less than or equal to +200 mK, and greater than or equal to −500 mK, preferably greater than or equal to −200 mK; and/or
   the semiconductor optical amplifier forms part of a photonic integrated circuit; and/or
   the interruption system includes a plurality of semiconductor optical amplifiers each configured to receive:
   a respective input optical signal, and
   a respective control signal, the control signal configured to control the semiconductor optical amplifier; and/or
at least two semiconductor optical amplifiers are at a different temperature; and/or
the same cooling device is configured to cool at least two semiconductor optical amplifiers; and/or
the cooling device includes a device for regulating the temperature of at least two semiconductor optical amplifiers; and/or
the control signal is a shared control signal for each of the optical semiconductor amplifiers; and/or
the control optical signal and the input optical signal have different polarisations; and/or
the wavelength of the input optical signal differs from the wavelength of the control optical signal by at least 0.05 nm, preferably by at least 0.1 nm, preferably by at least 0.5 nm, preferably by at least 1 nm, preferably by at least 1.5 nm and even more preferably by at least 5 nm; and/or
the power of the optical control signal is greater than or equal to −30 dBm, preferably greater than or equal to −10 dBm and less than or equal to +10 dBm, preferably less than or equal to +5 dBm; and/or
the power of the input optical signal is less than the power of the control optical signal by at least 5 dB; and/or
the cooling device comprises:
   a bar made of a material having a thermal conductivity greater than or equal to 20 watts per metre kelvin on which the amplifiers are arranged,
   a cold spot disposed at a first location of the bar, and
   a temperature control device comprising a temperature sensor disposed at a second location of the bar.

### BRIEF DESCRIPTION OF THE FIGURES

The invention will be better understood in the light of the following description which is given only as an indication and which is not intended to limit said invention, accompanied by the figures below:

FIG. 1 is a schematic representation of an interruption system according to the invention, according to a first embodiment,

FIG. 2 is a schematic representation of an interruption system according to the invention, according to a second embodiment,

FIG. 3a is a schematic representation of an interruption system according to the invention, according to a third embodiment,

FIG. 3b is a schematic representation of an interruption system according to the invention, according to a fourth embodiment,

FIG. 4 is a schematic representation of an interruption system according to the invention, according to a fifth embodiment,

FIG. 5 is a schematic representation of an interruption system according to the invention, according to a sixth embodiment,

FIG. 6 is a schematic representation of an interruption system according to the invention, according to a seventh embodiment,

FIG. 7 is a schematic representation of an interruption system according to the invention, according to an eighth embodiment,

FIG. 8 is a schematic representation of an interruption system according to the invention, according to a ninth embodiment, and

FIG. 9 is a schematic representation of an interruption system according to the invention, according to a tenth embodiment,

### DETAILED DESCRIPTION OF THE INVENTION

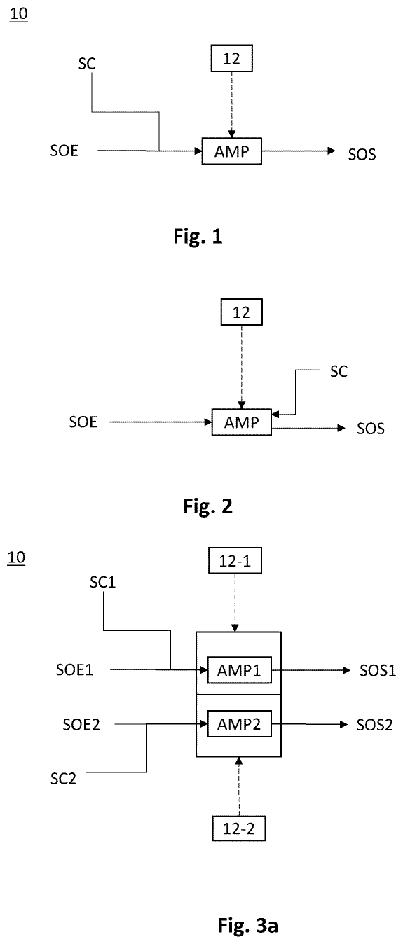

FIG. 1 shows an interruption system 10 configured to control transmission of an input optical signal SOE, the system including a semiconductor optical amplifier (AMP, AMP1, AMP2) configured to receive:
an input optical signal (SOE, SOE1, SOE2), and
a control signal (SC, SC1, SC2) configured to control the semiconductor optical amplifier (AMP, AMP1, AMP2),
   characterised in that the interruption system further comprises a cooling device (12, 12-1, 12-2) configured to cool the semiconductor optical amplifier (AMP, AMP1, AMP2) to a temperature greater than or equal to 10 K, preferably greater than or equal to 40 K, and to cool the optical modulator to a temperature less than or equal to 90 K, preferably less than or equal to 80 K.

The control signal SC is the signal conditioning the transmission and amplification of the input optical signal SOE by the solid state optical amplifier AMP.

The control signal SC may be electrical or optical.

Advantageously, when the control signal SC is optical, the control signal can be remote.

Advantageously, since the interruption system according to the invention is all-optical, the latter is not sensitive to electromagnetic disturbances.

Advantageously, the control signal SC can be used to provide the power supply to the semiconductor optical amplifier AMP.

It was surprisingly noted that the AMP semiconductor optical amplifier provided a non-zero gain when the latter was subjected to a cryogenic temperature, greater than or equal to 10 K, preferably greater than or equal to 40 K and less than or equal to 90 K, preferably less than or equal to 80 K, and that a low power supply, of the order of a few milliamperes was provided. Since the semiconductor optical amplifier AMP is energy efficient at this temperature, it is then possible to supply the switching energy to the semiconductor optical amplifier AMP via the control signal SC, in the form of an optical signal.

In this way the beam of a laser used to provide the optical SC control signal can also be used to power the semiconductor optical amplifier AMP.

In an all-optical interruption system according to the invention, the input optical signal SOE has a power different from that of the control signal SC. Preferably, the power of the input optical signal SOE is less than the power of the control signal so that the semiconductor optical amplifier AMP distinguishes the control signal SC from the input optical signal SOE.

The control signal of a semiconductor amplifier AMP is the signal having the highest power among the input optical signal SOE and the control signal SC.

The signal with the highest power between the input optical signal SOE and the control signal SC takes on the role of control signal even if it is not its initial function.

Thus, preferably the power of the input optical signal SOE is at least 5 dB lower than the power of the control signal SC, preferably at least 10 dB lower.

In one embodiment, the power of the control signal is greater than or equal to −30 dBm, preferably greater than or equal to-10 dBm and less than or equal to +10 dBm, preferably less than or equal to +5 dBm. The dBm is a unit that expresses a power in decibels (dB) with respect to a reference value of 1 milliwatt (mW).

The control signal SC may have a polarisation different from that of the input optical signal SOE. For example, the control signal SC is in electric transverse mode, respectively in magnetic transverse mode and the input optical signal SOE is in magnetic transverse mode, respectively in electric transverse mode.

The AMP solid-state optical amplifier is a bidirectional optoelectronic component. The input optical signal SOE and the optical control signal SC may be provided jointly using a single optical fiber at one of the terminals of the semiconductor optical amplifier AMP.

In one embodiment, shown in FIG. 2, the optical input signal SOE and the optical control signal SC are supplied to the semiconductor optical amplifier AMP in opposite directions via terminals on opposite sides of the amplifier. The input optical signal SOE and the control signal SC are considered to be counter-directional.

To facilitate the understanding of FIG. 2, the control signal SC and the output optical signal SOS have been shown separately to define the direction of propagation of these signals. However, the control signal SC and the optical output signal SOS are counter-propagating signals on the same optical fibre.

In another embodiment, regardless of whether the control signal SC and the input optical signal SOE have a different polarity or are transmitted to two opposite terminals of the semiconductor optical amplifier AMP, the wavelength of the control signal SC and the input optical signal SOE may be different. For example, the wavelength of the control signal SC and the input optical signal SOE is different by at least 0.05 nm, preferably by at least 0.1 nm, preferably by 0.5 nm, preferably by at least 1 nm, preferably by at least 1.5 nm and even more preferably by at least 5 nm.

In one embodiment, the interruption system 10 may include N semiconductor optical amplifiers, each configured to receive:
a respective input optical signal SOE1, SOE2, . . . . SOEN, and
a respective control signal SC1, SC2, . . . , SCN, the control signal being configured to control the semiconductor optical amplifier AMP1, AMP2, . . . , AMPN.

At least one of the N semiconductor optical amplifiers AMP1, AMP2, . . . , AMPN is configured to be cooled by the cooling device 12.

The cooling device may be the same for each of the N semiconductor optical amplifiers AMP1, AMP2, . . . , AMPN.

The cooling device may be the same for at least two of the N semiconductor optical amplifiers AMP1, AMP2, . . . , AMPN.

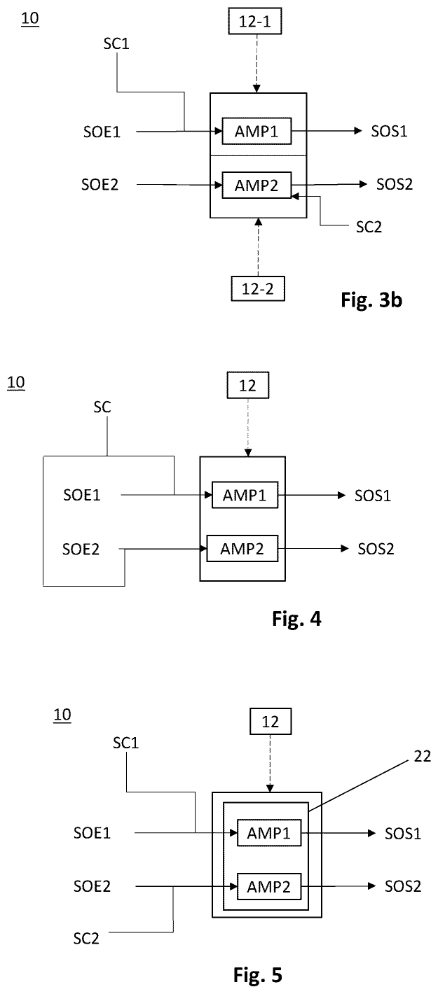

Each of the N semiconductor optical amplifiers AMP1, AMP2, . . . , AMPN may be cooled by a respective cooling device 12-1, 12-2 (illustrated in FIG. 3a).

Preferably, each of the semiconductor optical amplifiers AMP1, AMP2 of the interruption system is cooled by the cooling device to a cryogenic temperature, greater than or equal to 10 K, preferably greater than or equal to 40 K and less than or equal to 90 K, preferably less than or equal to 80 K.

For the rest of the description, to facilitate understanding, reference will only be made to two semiconductor optical amplifiers AMP1, AMP2. However, the description of embodiments involving two semiconductor optical amplifiers AMP1, AMP2 may also apply to N semiconductor optical amplifiers AMP1, AMP2, . . . , AMPN.

FIG. 3a illustrates an interruption device 10 including two semiconductor optical amplifiers AMP1, AMP2. For each of the two semiconductor optical amplifiers AMP1, AMP2, the input optical signals SOE1, SOE2 and the control signals SC1, SC2 are respectively supplied together using a single optical fibre to a terminal of the semiconductor optical amplifier.

Each of the two semiconductor optical amplifiers AMP1, AMP2 receives a respective input optical signal SOE1, SOE2 and a control signal SC1, SC2, so as to provide a respective output optical signal SOS1, SOS2.

FIG. 3b is almost identical to FIG. 3a and illustrates an interruption system 10 according to the invention, wherein in a first semiconductor optical amplifier AMP1 receives a first control signal SC1 in a first direction and a second semiconductor optical amplifier AMP2 receives a second control signal SC2 in a second direction opposite to the first direction.

In the same way as in FIG. 2, the control signal SC2 and the output optical signal SOS2 have been shown separately to define the direction of propagation of these signals. However, the control signal SC2 and the output optical signal SOS2 are counter-propagating signals at the same optical fibre.

In one embodiment, a first semiconductor optical amplifier AMP1 receives a first input optical signal SOE1 in a first direction and a second semiconductor optical amplifier AMP2 receives a second input optical signal SOE2 in a second direction opposite to the first direction. Each of the two semiconductor optical amplifiers AMP1, AMP2 is a bidirectional component.

The two semiconductor optical amplifiers AMP1, AMP2 are cooled by the same cooling device 12 or a respective cooling device.

Advantageously, the cooling device 12 can be shared using the same cooling device for two semiconductor optical amplifiers AMP1, AMP2.

The two semiconductor optical amplifiers AMP1, AMP2 can be maintained at the same temperature to amplify the input optical signals SOE1, SOE2 over the same wavelength range. This makes it possible, for example, to simultaneously amplify two signals belonging to the same range of wavelengths but with different operating points.

Alternatively, two semiconductor optical amplifiers AMP1, AMP2 may be maintained at a different temperature to amplify the input optical signals SOE1, SOE2 over a different wavelength range. For example, two semiconductor optical amplifiers AMP1, AMP2 are maintained at temperatures having a difference for example greater than or equal to 5K, and for example greater than or equal to 10K. In this way, the input signals SOE1, SOE2 can be amplified on different bandwidths.

In one embodiment, illustrated in FIG. 4, the same control signal SC is pooled for two semiconductor optical amplifiers AMP1, AMP2.

Advantageously, in this way, switching between transmission and interruption of data transmission can be ensured simultaneously at the semiconductor optical amplifiers AMP1, AMP2.

In the same way as in the embodiment shown in FIG. 4, wherein the control signal SC is shared, the input signal can be shared. A single input signal SOE could be split in two and supplied to two solid-state optical amplifiers AMP1, AMP2.

In one embodiment, the input optical signal SOE and the control signal SC are respectively shared for at least two amplifiers.

Advantageously, the same amplified signal can be provided at separate locations simultaneously.

In one embodiment, the input optical signal can be shared, while each semiconductor optical amplifier receives a respective control signal.

Advantageously, in this way it can be chosen, for the same input optical signal SOE, to choose at least one semiconductor optical amplifier to amplify the input optical signal.

In one embodiment, the shared input optical signal is supplied to two semiconductor optical amplifiers AMP1, AMP2 maintained at two different temperatures to amplify the input optical signal SOE over two different bandwidths.

In one embodiment, the at least one semiconductor optical amplifier AMP, AMP1, AMP2 is a discrete component.

Alternatively, a single solid-state optical amplifier AMP or a plurality of solid-state optical amplifiers AMP1, AMP2 may form part of an integrated circuit 22, as illustrated in FIG. 5. The integrated circuit 22 is for example a photonic integrated circuit.

The cooling device 12 of the interruption system 10 is preferably a cryogenic cooling device.

The cooling device 12 may be indirect. The cooling device is considered to be indirect if a cooling means does not act directly on the AMP semiconductor optical amplifier but on a thermally conductive element, for example, on which the semiconductor optical amplifier AMP is arranged. The thermally conductive element, cooled by a cooling means, will in turn cool the semiconductor optical amplifier AMP by thermal conduction.

An indirect cooling device 12 may for example be formed by a thermally conductive bar which will be cooled at one of its ends by a cooling means. The bar is configured to receive at least one semiconductor optical amplifier AMP.

Advantageously, an indirect cooling device allows a cooling means to be shared for several AMP, AMP1 and AMP2 semiconductor optical amplifiers. The bar may receive at least two AMP, AMP1, AMP2 semiconductor optical amplifiers on a thermally conductive bar, for example arranged at different locations.

Alternatively, the cooling device 12 may be direct. The direct cooling device 12 is a device configured to apply a thermal variation directly at the semiconductor optical amplifier AMP. The temperature control is carried out directly at the semiconductor optical amplifier AMP.

A direct cooling device may be formed by a dedicated cooling means for locally cooling the one or more semiconductor optical amplifiers AMP, AMP1, AMP2.

Advantageously, it is not necessary to have recourse to a conductive thermal structure on which the semiconductor optical amplifier(s) AMP, AMP1, AMP2 is/are arranged.

Advantageously, the use of a direct cooling device 12 allows better control of the temperature supplied to the at least one semiconductor optical amplifier AMP, AMP1, AMP2.

Also, as part of a direct cooling device 12, it is easier and faster to compensate for a variation in an semiconductor optical amplifier AMP. It is not necessary to wait for a conductive element to reach the desired temperature wherein the semiconductor optical amplifier AMP is located.

The cooling device 12 can be a passive cooling device.

For example, a passive cooling device can be a radiator in contact with the semiconductor optical amplifier AMP. The radiator radiates to the outside of the semiconductor optical amplifier AMP, such as a device for extracting thermal energy by radiation. A passive cooling device 12 may also be formed by a cooling circuit comprising liquid nitrogen.

A passive cooling device is devoid of an energy input. Advantageously, the energy consumption for maintaining the semiconductor optical amplifier(s) AMP, AMP1, AMP2 at a cryogenic temperature is reduced.

A cooling device 12 may be active. An active cooling device requires energy input to ensure cooling of the semiconductor optical amplifier AMP. Despite the need for energy input, temperature control of an optical semiconductor amplifier AMP is made faster and more reliable by controlling the cooling device by regulating its power supply.

To ensure accurate temperature control of the at least one or each of the semiconductor optical amplifiers AMP1, AMP2, the cooling device 12, 12-1, 12-2 may include a temperature controller 14, 14-1, 14-2 (illustrated in FIG. 7).

Preferably, the temperature controller 14, 14-1, 14-2 is configured to maintain the semiconductor optical amplifier AMP, AMP1, AMP2 at a target temperature with a margin less than or equal to +500 mK, preferably less than or equal to +200 mK, and greater than or equal to −500 mK, preferably greater than or equal to −200 mK.

Advantageously, precise control of the temperature of the semiconductor optical amplifier AMP, AMP1, AMP2 allows precise control of the wavelength range over which the latter amplifies the signal.

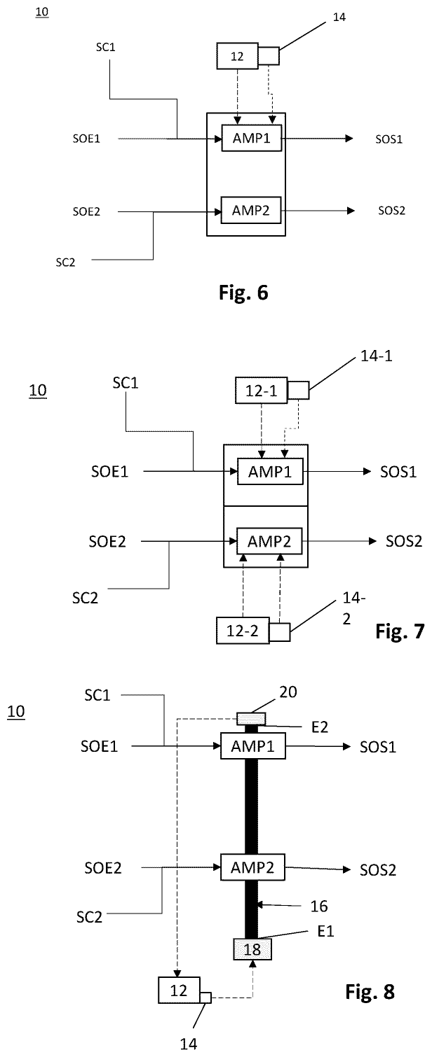

Also, the temperature regulator 14, 14-1, 14-2 makes it possible to compensate for the heat supplied by the control signal to the semiconductor optical amplifier AMP, AMP1, AMP2. The greater the power of the control signal SC, the greater the heat transmitted by this signal. Therefore, to ensure that the temperature of the semiconductor optical amplifier AMP, AMP1, AMP2 is controlled correctly, it is important to take into account the thermal impact of the SC control signal. The temperature controller 14 may be used to control the temperature of one of the plurality of semiconductor optical amplifiers AMP, AMP1, AMP2, as illustrated in FIG. 6.

FIG. 7 shows an interruption system according to the invention wherein each of the two semiconductor optical amplifiers AMP1, AMP2 includes a respective cooling device 12-1, 12-2 and a temperature regulator 14-1, 14-2.

Such a system, using cooling devices and respective temperature regulators, allows better control of the temperature of each of the two semiconductor optical amplifiers AMP1, AMP2.

FIG. 8 illustrates an example of the cooling device 14. The cooling device may include:
a bar 16 made of a material having a high thermal conductivity on which the N amplifiers are arranged (in the case of FIG. 8, two amplifiers AMP1, and AMP2 are illustrated),
a cold spot 18 disposed at a first location E1 of the bar 16, and
a temperature regulating device 14 comprising a temperature sensor 20 arranged at a second location E2 of the bar.

Preferably, the bar 16 has a thermal conductivity greater than or equal to 20 watts per metre kelvin. The temperature at different locations of the bar 30 is different.

In an embodiment, the bar 16 is made of copper.

The bar can be made of a material having a high thermal conductivity and the presence of a cold spot 18 makes it possible to create a temperature gradient between the first place E1 wherein the cold source 18 is arranged and one end E2 of the bar 16.

With such a temperature gradient, the positioning of the semiconductor optical amplifiers AMP1, AMP2 is important to be at a desired target temperature T1, T2.

The temperature of the semiconductor optical amplifiers AMP1, AMP2 arranged on rod 16 is conditioned by their location on rod 16.

The cold spot 18 corresponds to a cooling means configured to cool the bar 16 at a particular location on this bar 16 corresponding to the first location E1.

In this way, the amplifiers arranged closest to the cold spot 18 have a colder temperature than the amplifiers furthest from the cold spot 18.

Preferably, the cooling means used is a cryogenic cooler.

The cold spot 18 is preferably positioned at one end of the bar 16 to maximise the temperature gradient between a first end and a second end of the bar 16.

The positioning of a temperature sensor 20 at a second location E2 of the bar 16 makes it possible to determine the temperature of the bar 16 at this second location E2. Since the bar is made of a conductive material, it can be determined, from the measurement of the temperature sensor 34, at least approximately the temperature at each point of the bar 16 and more particularly at the positions wherein the AMP1, AMP2 semiconductor optical amplifiers are located.

Advantageously, from the temperature measurement at said second location E2 of rod 16, cooling device 12 can determine whether the temperature of semiconductor optical amplifiers AMP1, AMP2 corresponds to the desired target temperature.

If the temperature of at least one semiconductor optical amplifier AMP1, AMP2 is different from the desired target temperature T1, T2, the cooling device 12 controls the regulating device 14 to regulate the temperature of the cold spot 18 of the bar 16.

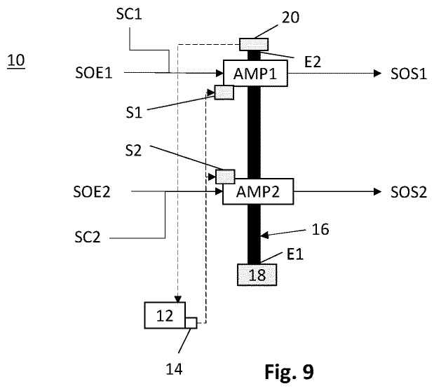

In another embodiment shown in FIG. 9, the cooling device independently controls the temperature T1, T2 of the AMP1, AMP2 semiconductor optical amplifiers. If one of the semiconductor optical amplifiers AMP1, AMP2 is not at a desired target temperature, the temperature regulator 14 independently regulates the temperature of this amplifier AMP1, AMP2.

Each of the semiconductor optical amplifiers AMP1, AMP2 is associated with a respective additional thermal source S1, S2. Each of the additional heat sources S1, S2 is configured to individually regulate the temperature of one of the semiconductor optical amplifiers AMP1, AMP2.

In one embodiment, the N additional thermal sources are Peltier modules and/or resistors.

Advantageously, the Peltier modules make it possible to regulate the temperatures of the semiconductor optical amplifiers AMP1, AMP2 by locally increasing or decreasing their temperature.

Advantageously, the resistors make it possible to regulate the temperatures of the semiconductor optical amplifiers AMP1, AMP2 by locally increasing their temperature.

The embodiment shown in FIG. 9 is similar to the configuration shown in FIG. 8, but the temperature controller 14 is different. The temperature controller 14 no longer regulates the temperature of the cold point 18 of the rod 16, but directly regulates the temperature of the additional heat sources S1, S2.

The embodiment illustrated in FIG. 9 may be devoid of the bar 16 and the cold spot 18, the heat sources S1 and S2 supplying the cold to the semiconductor amplifiers S1, S2.

The invention has been described above with the aid of embodiments shown in the figures, without limitation of the general inventive concept.

Many other modifications and variations suggest themselves to those skilled in the art, after reflection on the different embodiments illustrated in this application.

These embodiments are given by way of example and are not intended to limit the scope of the invention, which is determined exclusively by the claims below.

In the claims, the word “comprising” does not exclude other elements or steps. The mere fact that different features are listed as mutually dependent claims does not indicate that a combination of these features cannot be advantageously used. Finally, any reference used in the claims shall not be construed as limiting the scope of the invention.

1. An interruption system configured to control transmission of an optical signal, the system including a semiconductor optical amplifier configured to receive:
an input optical signal, and
a control signal configured to control the semiconductor optical amplifier,
characterised in that the interruption system further comprises a cooling device configured to cool the semiconductor optical amplifier to a temperature greater than or equal to 10 K, and to cool the optical modulator to a temperature less than or equal to 90 K.

2. The interruption system according to claim 1, characterised in that the control signal is an electrical signal.

3. The interruption system according to claim 1, characterised in that the control signal is an electrical signal.

4. The interruption system according to claim 3, characterised in that the semiconductor optical amplifier is a bi-directional component configured to receive the input optical signal and the control optical signal in opposite directions.

5. The interruption system according to claim 1, characterised in that the cooling device is direct.

6. The interruption system according to claim 1, characterised in that the cooling device is indirect.

7. The interruption system according to claim 1, characterised in that the cooling device includes a temperature regulator, the temperature regulator being configured to maintain the semiconductor optical amplifier at a target temperature with a margin a margin less than or equal to 500 mK and greater than or equal to −500 mK.

8. The interruption system according to claim 1, characterised in that the semiconductor optical amplifier forms part of an integrated photonic circuit.

9. The interruption system according to claim 1, characterised in that the interruption system includes a plurality of semiconductor optical amplifiers each configured to receive:
a respective input optical signal, and
a respective control signal, the control signal being configured to control the semiconductor optical amplifier.

10. The interruption system according to claim 9, characterized in that at least two semiconductor optical amplifiers are at a different temperature.

11. The interruption system according to claim 9, characterised in that the control signal is a shared control signal for each of the semiconductor optical amplifiers.

12. The interruption system according to claim 9, characterised in that the same cooling device is configured to cool at least two semiconductor optical amplifiers.

13. The interruption system according to claim 3, characterised in that the control optical signal and the input optical signal have different polarisations.

14. The interruption system according to claim 3, characterised in that the wavelength of the input optical signal differs from the wavelength of the control optical signal by at least 0.05 nm.

15. The interruption system according to claim 3, characterised in that the power of the optical control signal is greater than or equal to −30 dBm and less than or equal to +10 dBm.

16. The interruption system according to claim 3, characterised in that the power of the input optical signal is less than the power of the control optical signal by at least 5 dB.
